(19) United States
(12) Patent Application Publication
(10) Pub. No.: US 2017/0024601 A1
(43) Pub. Date: Jan. 26, 2017

(54) BIOMETRIC IDENTIFICATION APPARATUS

(71) Applicant: eGalax_eMPIA Technology Inc., Taipei City (TW)

(72) Inventor: Po-Chuan LIN, Taipei City (TW)

(21) Appl. No.: 14/988,402

(22) Filed: Jan. 5, 2016

(30) Foreign Application Priority Data
Jul. 22, 2015 (TW) 104123708

(51) Int. Cl. G06K 9/00; G06F 21/32

(52) U.S. Cl. CPC G06K 9/00013; G06F 21/32; G06K 9/00892; G06K 9/00087; G06K 9/00906; G06K 2009/00939

(57) ABSTRACT

A biometric identification apparatus includes a control module, a fingerprint identification module including a fingerprint scan controller and a fingerprint receiver, a pulsatile blood flow detection module including one or multiple light sources and a photo detector, and a holder body defining a fingerprint identification zone and a pulsatile blood flow identification zone. In application, the user simply needs to press the fingertip of one single finger on the fingerprint identification zone and pulsatile blood flow identification zone of the holder body so that the biometric identification apparatus can detect user's fingerprint and pulsatile blood flow signals, fetch and convert characteristic data of detected signals, and then match fetched fingerprint and pulsatile blood flow characteristic data with respective reference data for security access control. The application of this dual-biometric identification technology greatly increases the cracking difficulty, achieving better anti-theft function.

This application claims the priority benefit of Taiwan patent application number 104123708, filed on Jul. 22, 2015

### BACKGROUND OF THE INVENTION

1. Field of the Invention

The present invention relates to biometric identification technology and more particularly, to a biometric identification apparatus that employs dual-biometric identification technology to identify fingerprint and pulsatile blood flow signals for security access control, enhancing the anti-theft effect.

2. Description of the Related Art

When markets have become more aware of security issues, the convention locks, combination blocks or locks applied to mobile phones are vulnerable, manufacturers keep creating security technologies in different ways. At this time, the current maturity of several biometric identification technologies has get manufacturers' and consumers' attention. The common biometric identification technologies use different sensors to detect different biometric features such as fingerprint, palm-print, face shape, heartbeat, iris or DNA, etc. These methods have their advantages and disadvantages. However, because a fingerprint is an impression left by the friction ridges of a human finger, we leave behind fingerprints on door handle, elevator button, and many other items that we touch in our daily life. Thus, an evil person can easily collect fingerprints left behind by a person for creating forged fingerprints. For example, attaching a forged fingerprint pattern on one finger of another person or a fake finger can pass the fingerprint check of a fingerprint sensor. Therefore, manufacturers began to study how to solve the problem that conventional fingerprint identification devices are vulnerable to hackers.

The application of fingerprint identification technology has been seen in our living environment. The heartbeat (pulsatile blood flow) biometric identification technique has also been used in the medical field. Because the tissue layers of fingers and earlobes are thin and full of capillaries, fingers and earlobes are quite suitable points for precise measurements. While taking into consideration the factor of ease of use, the most current biometric identification technologies are configured to choose finger as the measuring point. These prior art biometric identification designs generally uses at least one visible or invisible light source to emit light toward the fingertip of the finger, and a photo detector to detect reflected light so as to measure changes in reflected light subject to the blood flow in the fingertip microcirculation during systole and diastole, and thus, presence or absence of heartbeat, frequency or more subtle change signals can be measured. For example, monitoring devices with detecting components for clamping on or attaching to fingers are commonly seen in hospitals. However, these monitoring devices commonly have the drawbacks of large size and high power consumption, thus, the mobility and power supply applications of these monitoring devices are restricted.

Because mobile electronic devices have become popular and mobile electronic device security problem is an issue of concern, the application of fingerprint identification technology can be seen in mobile phones. However, conventional fingerprint identification designs are still vulnerable to hackers. However, with the development that more and more people are accustomed to using a mobile electronic device for storing personal or confidential data, the anti-theft security function has deserved much more users attention. Therefore, it is desirable to provide a biometric identification apparatus having the characteristics of small size, ease of use and not vulnerable to hackers.

### SUMMARY OF THE INVENTION

The present invention has been accomplished under the circumstances in view. It is therefore the main object of the present invention to provide a biometric identification apparatus, which comprises a control module, a fingerprint identification module comprising a fingerprint scan controller and a fingerprint receiver and electrically connected to the control module, and a pulsatile blood flow detection module comprising at least one light source and a photo detector and electrically connected to the control module. The biometric identification apparatus detects user's fingerprint and pulsatile blood flow signals, fetches and converts characteristic data of detected signals, and then matches fetched fingerprint and pulsatile blood flow characteristic data with respective reference data for security access control. Because a fake finger or fingerprint provides no pulsatile blood flow signal, the application of the dual-biometric identification technology in accordance with the present invention greatly increases the cracking difficulty, achieving better anti-theft function.

Further, the user's pulsatile blood flow signal can be used for determining the presence of a heartbeat, and can also be used for matching with storage user pulsatile blood flow reference characteristic data. The pulsatile blood flow characteristic data can be heart pulse or oxygen content of the blood. Thus, matching items can be increased. The pulsatile blood flow detection module can record signal waveforms generated by changes in reflected light subject to the blood flow in the fingertip microcirculation during systole and diastole. Because every person can generate a specific pulsatile blood flow waveform, waveform matching can enhance the precision. In this way you can increase the cracking difficulty, achieving better anti-theft function.

Further, the combined surface area of the fingerprint identification zone and the pulsatile blood flow identification zone is approximately equal to the surface area of the finger pad of one single finger. In application, the user simply needs to press the fingertip of one single finger on the fingerprint identification zone and pulsatile blood flow identification zone of the holder body for allowing detection of fingerprint and heartbeat, enhancing biometric identification speed and convenience.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a circuit block diagram of biometric identification apparatus in accordance with the present invention.

FIG. 2 is a top view of the biometric identification apparatus in accordance with the present invention.

FIG. 3 is an operational flow chart of the present invention (I).

FIG. 4 is an operational flow chart of the present invention (I).

FIG. 5 is a fingerprint chart of a fingerprint signal obtained according to the present invention.

FIG. 6 is a series of waveform charts of pulsatile blood flow signals obtained according to the present invention.

### DETAILED DESCRIPTION OF THE PREFERRED EMBODIMENT

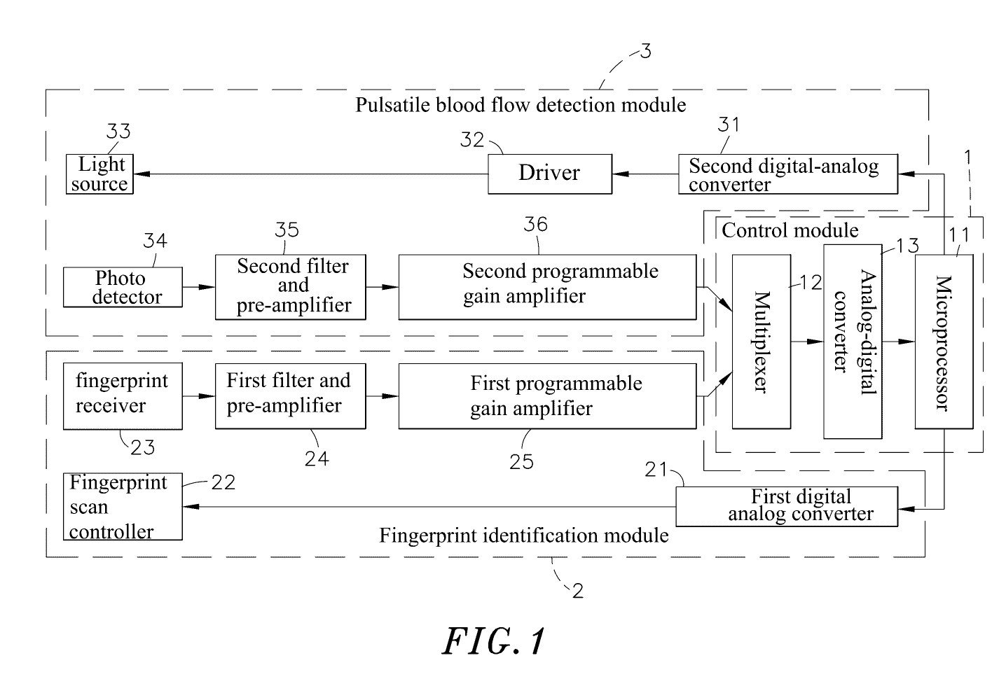

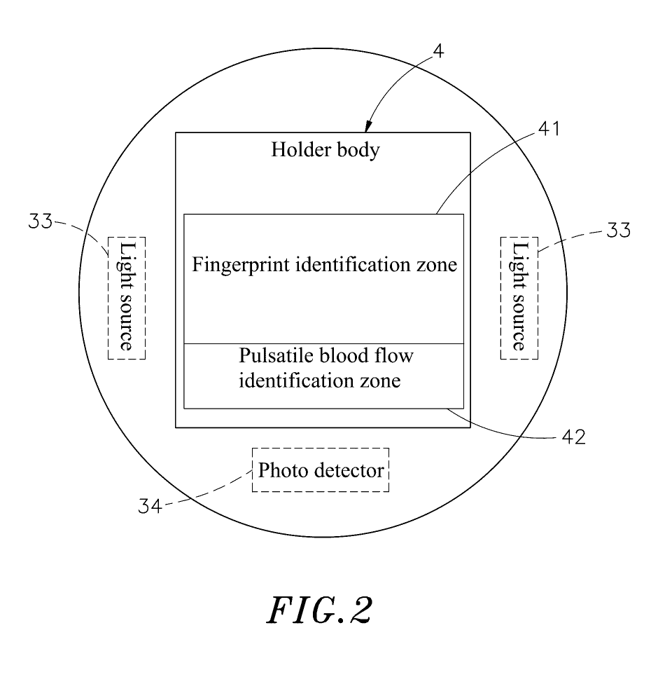

Referring to FIGS. 1 and 2, a biometric identification apparatus in accordance with the present invention generally comprises a control module 1, a fingerprint identification module 2, a pulsatile blood flow detection module 3 and a holder body 4.

The control module 1 comprises a microprocessor 11, a multiplexer 12 and an analog-digital converter 13. The analog-digital converter 13 is electrically connected between the microprocessor 11 and the multiplexer 12. The multiplexer 12 is adapted for receiving signals from the fingerprint identification module 2 and the pulsatile blood flow detection module 3 and transmitting received signals to the analog-digital converter 13. The analog-digital converter 13 is adapted for converting each inputted analog signal to a corresponding digital signal and then transmitting the converted digital signal to the microprocessor 11. The control module 1 is adapted for controlling the fingerprint identification module 2 and the pulsatile blood flow detection module 3 to start detection and receiving feedback signals from the fingerprint identification module 2 and the pulsatile blood flow detection module 3, and then analyzing feedback signals or matching feedback signals with databank storage data by means of the microprocessor 11.

The fingerprint identification module 2 comprises a first digital-analog converter 21 electrically connected to the microprocessor 11 and adapted for receiving each inputted digital signal from the microprocessor 11 and converting it to a corresponding analog signal for output, a fingerprint scan controller 22 electrically connected to the first digital-analog converter 21 for receiving each analog signal outputted by the first digital-analog converter 21, a fingerprint receiver 23 adapted for receiving signals from the fingerprint scan controller 22, a first filter and pre-amplifier 24 electrically connected to the fingerprint receiver 23 and adapted for filtering and boosting fingerprint signals from the fingerprint receiver 23, a first programmable gain amplifier 25 electrically connected to the first filter and pre-amplifier 24 and adapted for amplifying filtered and boosted fingerprint signals from the first filter and pre-amplifier 24 and then transmitting amplified fingerprint signals to the multiplexer 12.

The pulsatile blood flow detection module 3 comprises a second digital-analog converter 31 electrically connected to the microprocessor 11, a driver 32 having the input end thereof electrically connected to the second digital-analog converter 31, at least one light source 33 electrically connected to the output end of the driver 32, at least one photo detector 34, a second filter and pre-amplifier 35 having the input end thereof electrically connected to the at least one photo detector 34, a second programmable gain amplifier 36 having the input end thereof electrically connected to the output end of the second filter and pre-amplifier 35 and the output end thereof electrically connected to the multiplexer 12.

The holder body 4 is covered over the fingerprint identification module 2 and pulsatile blood flow detection module 3 at a top side, comprising a fingerprint identification zone 41 and a pulsatile blood flow identification zone 42 arranged adjacent to each other at a top side thereof. The combined surface area of the fingerprint identification zone 41 and the pulsatile blood flow identification zone 42 is approximately equal to the surface area of the finger pad of one single finger. The at least one light source 33 and the at least one photo detector 34 can be disposed in the holder body 4 beyond the fingerprint identification zone 41 and the pulsatile blood flow identification zone 42. Alternatively, the at least one light source 33 and the at least one photo detector 34 can be disposed in the holder body 4 beneath the fingerprint identification zone 41 and the pulsatile blood flow identification zone 42.

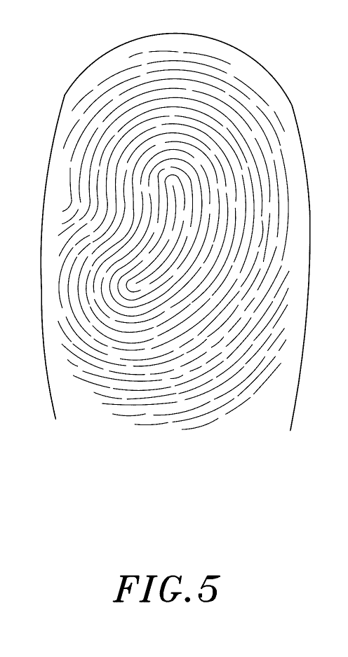

When a user places the fingertip of his or her one single finger on the fingerprint identification zone 41 and the pulsatile blood flow identification zone 42, the fingerprint identification module 2 will scan the fingerprint of the finger, and at the same time, the pulsatile blood flow detection module 3 will detect a fingertip pulsatile blood flow signal. The fingerprint identification module 2 can be a capacitive, optical, RF (radiofrequency) biological or electrothermal type fingerprint identification module. During the operation of the fingerprint identification module 2 to scan the fingerprint of the user's finger that is placed on the fingerprint identification zone 41 (in the case that the fingerprint identification module 2 is of a capacitive design), the fingerprint scan controller 22 provides a driving signal to electrodes that measure different capacitance values for distinguishing between fingerprint ridges and valleys and generate different waveform signals corresponding to the respective measured capacitance values (see FIG. 5). During the operation of the pulsatile blood flow detection module 3 to detect a fingertip pulsatile blood flow signal from the fingertip that is placed on the pulsatile blood flow identification zone 42, one single light source 33 is driven to emit red or infrared light onto the fingertip the pulsatile blood flow identification zone 42, and the photo detector 34 measures changes in reflected red or infrared light produced by blood flowing in and out of the fingertip subject to heart pulse and blood pressure change. Further, red and infrared light sources 33 can be arranged beneath the pulsatile blood flow identification zone 42 and alternatively driven to emit red or infrared light toward the fingertip at the pulsatile blood flow identification zone 42 so that the photo detector 34 can measure changes in oxygen content of the blood subject to the characteristics that the absorption spectra of oxygenated and reduced haemoglobin differ; when two compounds with differing absorption spectra are together in solution, the ratio of their concentrations can be determined from the ratio of the light absorbed at two different wavelengths; deoxygenated haemoglobin preferentially reflects the light at 940 nm (infrared) and oxygenated haemoglobin (HbO2) at 660 nm (red).

Referring to FIG. 3 and FIGS. 1 and 2 again, the operation of the biometric identification apparatus comprises the steps of:

(501) Start.

(502) The fingerprint identification module 2 scans the user's fingerprint, and, the pulsatile blood flow detection module 3 detects a pulsatile blood flow signal of the blood flow in the fingertip microcirculation.

(503) Convert the measured fingerprint and pulsatile blood flow signal to corresponding fingerprint characteristic data and pulsatile blood flow characteristic data.

(504) Match the fingerprint characteristic data thus obtained with the storage user characteristic reference data in the databank, and then proceed to step (505) if matched, or step (507) if not matched.

(505) Match the pulsatile blood flow characteristic data thus obtained with the storage user characteristic reference data in the databank, and then proceed to step (506) if matched, or step (507) if not matched.

(506) Send out the signal of “CORRECT” and allow the user to carry out the subsequent use.

(507) Send out the signal of “INCORRECT”.

Referring to FIGS. 4-6 and FIGS. 1-3 again, in an alternate form of the present invention, the operation of the biometric identification apparatus comprises the steps of:

(601) Start.

(602) The fingerprint identification module 2 scans the user's fingerprint, and, the pulsatile blood flow detection module 3 detects a pulsatile blood flow signal of the blood flow in the fingertip microcirculation.

(603) Convert the measured fingerprint and pulsatile blood flow signal to corresponding fingerprint characteristic data and pulsatile blood flow characteristic data.

(604) Match the fingerprint characteristic data thus obtained with the storage user characteristic reference data in the databank, and then proceed to step (605) if matched, or step (607) if not matched.

(605) Determine whether or not a finger blood flow signal detected? And then proceed to step (606) if yes, or step (607) if not.

(606) Send out the signal of “CORRECT” and allow the user to carry out the subsequent use.

(607) Send out the signal of “INCORRECT”.

It can be seen from the above description that in addition to the fingerprint identification module 2 for scanning a fingerprint, the invention further comprises a pulsatile blood flow detection module 3 for detecting a pulsatile blood flow signal of the blood flow in the fingertip microcirculation of one finger of a user; further, the combined surface area of the fingerprint identification zone 41 and pulsatile blood flow identification zone 42 is approximately equal to the surface area of the finger pad of one single finger so that when a user places the fingertip of one single finger on the fingerprint identification zone 41 and pulsatile blood flow identification zone 42, the biometric identification apparatus immediately scan the fingerprint of the user's finger for matching and simultaneously detect a pulsatile blood flow signal for matching and will allow the user to carry out the subsequent use only after the two matching procedures have been succeeded. Since one single press of one single finger can achieve detection of two biometric characteristics, the invention facilitates quick and convenient use.

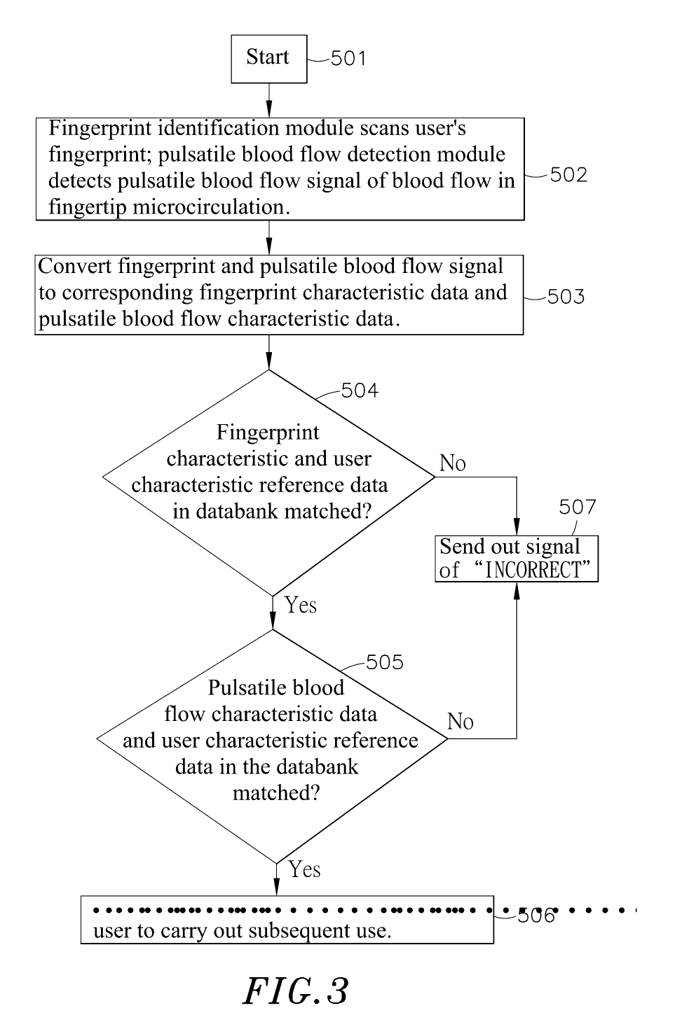

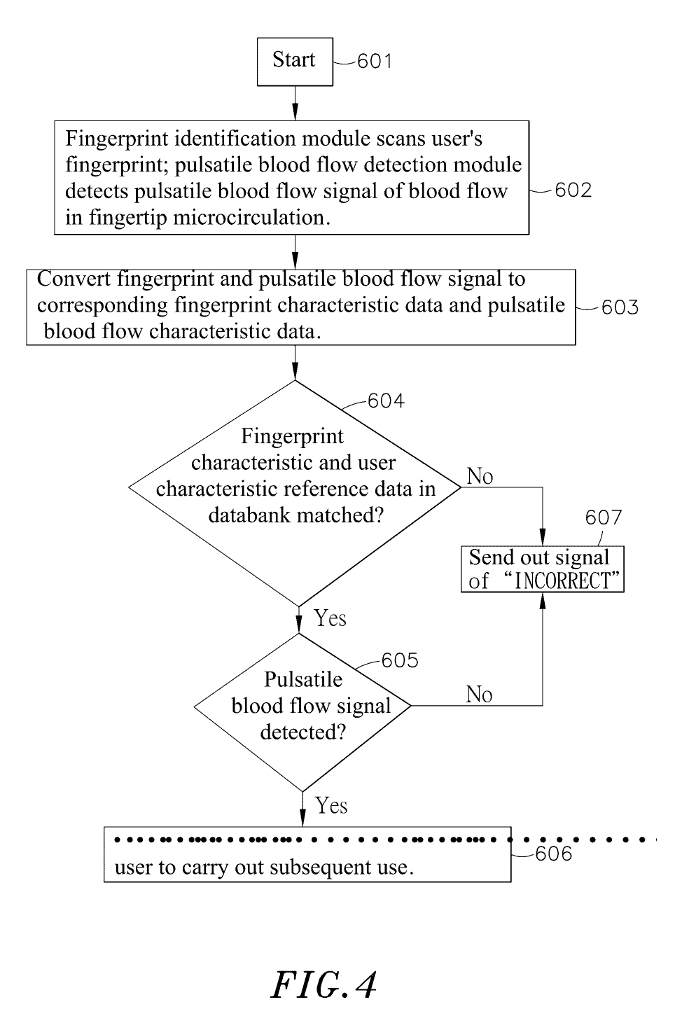

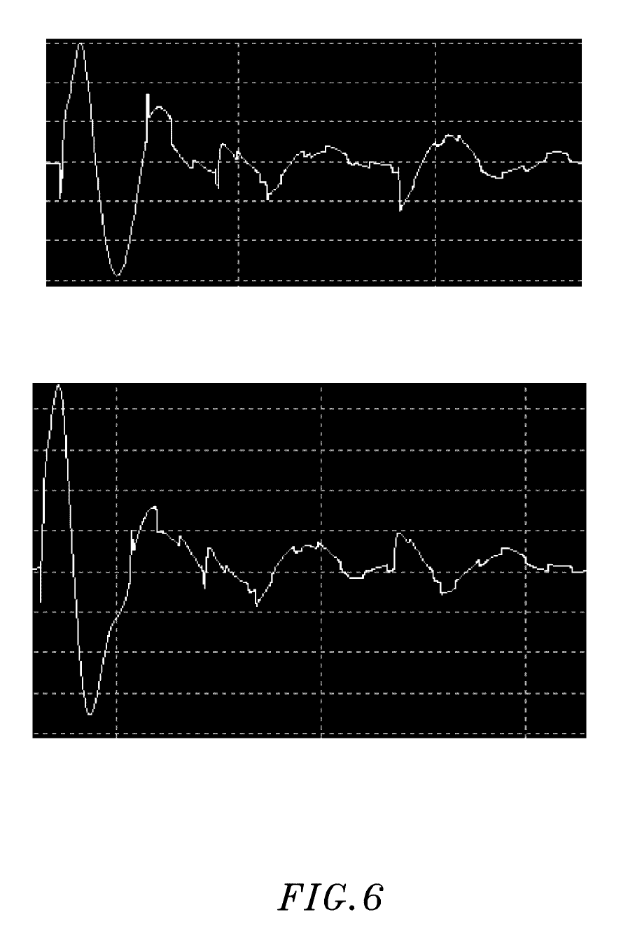

As illustrated in FIG. 3 and FIG. 4, two identification methods can be selectively applied to the pulsatile blood flow identification zone 42. The first identification method illustrated in Step (605) is simply configured to detect the presence of a heartbeat where the pulsatile blood flow detection module 3 and the fingerprint identification module 2 are adapted for the determination that the object being placed on the pulsatile blood flow identification zone 42 is a live finger or fake finger so as to stop the access to secured data and location by using a fake finger, enhancing the anti-theft effect. The second identification method illustrated in Step (505) uses a detection module of relatively higher resolution (for example, 12 bit or above) for detecting a fingertip pulsatile blood flow signal. It records signal waveforms generated by changes in reflected light subject to the blood flow in the fingertip microcirculation during systole and diastole. The biometric characteristic to be detected can be pulse or blood oxygen. Thus, the invention implements a double-precision identification procedure of detecting the two biometric characteristics of fingerprint and heartbeat. The pulsatile blood flow signal detecting and matching procedures greatly enhance identification precision. Because every person can generate a specific pulsatile blood flow waveform, waveform matching can enhance the precision (see FIG. 6). In this way you can increase the cracking difficulty, achieving better anti-theft function.

The aforesaid fingerprint signal characteristic matching can be based on overall pattern matching, or, ridge ending and bifurcation feature matching. The pulsatile blood flow signal matching can be based on overall pattern matching, P wave matching, PR interval matching, QRS complex wave matching, or ST segment elevation matching. As fingerprint signal characteristic and pulsatile blood flow signal matching techniques are of the known art and not within the scope of claims of the invention, no further detailed description in this regard will be necessary.

Further, the invention can use the pulsatile blood flow detection module 3 and the fingerprint identification module 2 to obtain a finger pulse signal and a finger fingerprint signal respectively from the pressed finger. At this time, the control module 1 receives the detected finger pulse signal from the pulsatile blood flow detection module 3 and the detected fingerprint signal from the fingerprint identification module 2, and then matches the characteristic features of the received fingerprint signal with predetermined reference fingerprint characteristic features after received the finger pulse signal. Thus, the fingerprint matching procedure can be performed only after the pressed finger has been identified to be a live finger, simplifying the processing operation of the control module 1 and saving much power consumption. Further, the pulsatile blood flow detection module 3 and the fingerprint identification module 2 can be defined to obtain a finger pulse signal and a fingerprint signal at the same time.

Alternatively, the invention can be configured for enabling the pulsatile blood flow detection module 3 to detect a finger pulse signal at first, and then enabling the fingerprint identification module 2 to detect a fingerprint signal, and, the detection order between the pulsatile blood flow detection module 3 and the fingerprint identification module 2 can be reversed without departing from the spirit and scope of the invention.

In conclusion, the invention provides a biometric identification apparatus comprising a control module, a fingerprint identification module, a pulsatile blood flow detection module and a holder body defining a fingerprint identification zone and a pulsatile blood flow identification zone. The biometric identification apparatus detects user's fingerprint and pulsatile blood flow signals, fetches and converts characteristic data of detected signals, and then matches fetched fingerprint and pulsatile blood flow characteristic data with respective reference data for security access control. In application, the user simply needs to press the fingertip of one single finger on the fingerprint identification zone and pulsatile blood flow identification zone of the holder body for allowing detection of fingerprint and pulsatile blood flow signals. The application of this dual-biometric identification technology greatly increases the cracking difficulty, achieving better anti-theft function.

Although particular embodiments the invention have been described in detail for purposes of illustration, various modifications and enhancements may be made without departing from the spirit and scope of the invention. Accordingly, the invention is not to be limited except as by the appended claims.

What the invention claimed is:

1. A biometric identification apparatus, comprising a control module, a fingerprint identification module, a pulsatile blood flow detection module and a holder body, wherein;
said control module is electrically connected to said fingerprint identification module and said pulsatile blood flow detection module and adapted for controlling said fingerprint identification module and said pulsatile blood flow detection module to start detection, receding detected feedback signals from said fingerprint identification module and said pulsatile blood flow detection module and using the data of said detected feedback signals for analysis and matching through a microprocessor thereof;
said fingerprint identification module comprises a fingerprint scan controller controllable by said microprocessor of said control module to generate a scan control signal, and a fingerprint receiver adapted for receiving signals from said fingerprint scan controller and transmitting received signals to said microprocessor of said control module;
said pulsatile blood flow detection module comprises at least one light source controllable by said microprocessor of said control module to emit light, and at least one photo detector adapted for receiving light and outputting signals to said microprocessor of said control module;
said holder body covered over said fingerprint identification module and said pulsatile blood flow detection module at a top side, said holder body comprising a fingerprint identification zone and a pulsatile blood flow identification zone arranged adjacent to each other at a top side thereof, the combined surface area of said fingerprint identification zone and said pulsatile blood flow identification zone being approximately equal to the surface area of the finger pad of one single finger of a human being;
wherein when a user places the fingertip of one single finger thereof on said fingerprint identification zone and said pulsatile blood flow identification zone, said fingerprint identification module detects the fingerprint of said finger and provides the detected fingerprint signal to said control module, said pulsatile blood flow detection module detects a fingertip pulsatile blood flow signal from said finger and provides the detected fingertip pulsatile blood flow signal to said control module; said control module receives said fingerprint signal from said fingerprint identification module and said fingertip pulsatile blood flow signal from said pulsatile blood flow detection module, fetches fingerprint and pulsatile blood flow characteristic data from said fingerprint signal and said fingertip pulsatile blood flow signal, matches said fingerprint and pulsatile blood flow characteristic data with predetermined fingerprint and pulsatile blood flow reference data, and then outputs a signal of “CORRECT” for allowing the user to carry out the subsequent use after the matching succeeded.

2. The biometric identification apparatus as claimed in claim 1, wherein said control module comprises a microprocessor, a multiplexer and an analog-digital converter, said analog-digital converter being electrically connected between said microprocessor and said multiplexer, said multiplexer being adapted for receiving said fingerprint signal from said fingerprint identification module and said fingertip pulsatile blood flow signal from said pulsatile blood flow detection module and transmitting said fingerprint signal and said fingertip pulsatile blood flow signal to said analog-digital converter, said analog-digital converter being adapted for converting each inputted analog signal to a corresponding digital signal and then transmitting the converted digital signal to said microprocessor; said fingerprint identification module comprises a first digital-analog converter electrically connected to said microprocessor and adapted for receiving each inputted digital signal from said microprocessor and converting each received digital signal to a corresponding analog signal for output, a fingerprint scan controller electrically connected to said first digital-analog converter for receiving each analog signal outputted by said first digital-analog converter, a fingerprint receiver adapted for receiving signals from said fingerprint scan controller, a first filter and pre-amplifier electrically connected to said fingerprint receiver and adapted for filtering and boosting fingerprint signals from said fingerprint receiver, a first programmable gain amplifier electrically connected to said first filter and pre-amplifier and adapted for amplifying filtered and boosted fingerprint signals from said first filter and pre-amplifier and then transmitting amplified fingerprint signals to said multiplexer.

3. The biometric identification apparatus as claimed in claim 1, wherein said control module comprises a microprocessor, a multiplexer electrically connected to said fingerprint identification module and said pulsatile blood flow detection module for receiving signals therefrom, an analog-digital converter electrically connected to said multiplexer and adapted for converting inputted analog signals from said multiplexer to digital signals and transmitting converted digital signals to said microprocessor; said pulsatile blood flow detection module comprises a second digital-analog converter electrically connected to said microprocessor for receiving control signals therefrom, a driver electrically connected to said second digital-analog converter for receiving signals outputted by said second digital-analog converter, at least one light source electrically connected to said driver and drivable by said driver, at least one photo detector for detecting a fingerprint signal, a second filter and pre-amplifier electrically connected to said at least one photo detector for filtering and pre-amplifying the fingerprint signal outputted from said at least one photo detector, and a second programmable gain amplifier electrically connected to said second filter and pre-amplifier and said multiplexer for amplifying the fingerprint signal outputted from said second filter and pre-amplifier and transmitting the amplified fingerprint signal to said multiplexer.

4. The biometric identification apparatus as claimed in claim 1, wherein said control module outputs a signal of “INCORRECT” to stop the user from carrying out the subsequent use if the matching between said fingerprint characteristic data with said predetermined fingerprint reference data failed.

5. The biometric identification apparatus as claimed in claim 1, wherein said control module outputs a signal of “INCORRECT” to stop the user from carrying out the subsequent use if the matching between said pulsatile blood flow characteristic data with said predetermined pulsatile blood flow reference data failed.

6. The biometric identification apparatus as claimed in claim 1, wherein said control module fetches characteristic features of the detected fingerprint signal from said fingerprint identification module and converts the fetched fingerprint characteristic features to said fingerprint characteristic data, and then matches said fingerprint characteristic data with said fingerprint reference data for further security access control only after received the detected fingertip pulsatile blood flow signal from said pulsatile blood flow detection module.

7. The biometric identification apparatus as claimed in claim 1, wherein said pulsatile blood flow detection module starts to detect said fingertip pulsatile blood flow signal from said finger at the time said fingerprint identification module is started to detect the fingerprint of said finger; said control module fetches characteristic features of the detected fingerprint signal from said fingerprint identification module and the detected pulsatile blood flow signal from said pulsatile blood flow detection module, and then converts the fetched fingerprint characteristic features and pulsatile blood flow characteristic features to said fingerprint characteristic data and said pulsatile blood flow characteristic data, and then matches said fingerprint characteristic data with said fingerprint reference data, and then matches said pulsatile blood flow characteristic data with said pulsatile blood flow reference data for further security access control only after the matching between said fingerprint characteristic data and said fingerprint reference data succeeded

8. A biometric identification apparatus, comprising:
a pulsatile blood flow detection module adapted for detecting a finger pulse signal from one single finger of a user;
a fingerprint identification module adapted for detecting a fingerprint signal from said finger of said user; and
a control module adapted for receiving said finger pulse signal from said pulsatile blood flow detection module and said fingerprint signal from said fingerprint identification module, and the matching predetermined characteristic data of said fingerprint signal with predetermined reference fingerprint characteristic data after received said finger pulse signal.

9. The biometric identification apparatus as claimed in claim 8, wherein said fingerprint identification module detects said fingerprint signal at the time said pulsatile blood flow detection module detects said finger pulse signal.
